(19) United States
(12) Patent Application Publication
(10) Pub. No.: US 2025/0320849 A1
(43) Pub. Date: Oct. 16, 2025

(54) PASSIVE BRAKE UNIT FOR A WIND TURBINE

(71) Applicant: The Carlson Company, Inc., Park City, KS (US)

(72) Inventor: Rodney Bruntz, Valley Center, KS (US)

(21) Appl. No.: 18/636,011

(22) Filed: Apr. 15, 2024

(51) Int. Cl. F03D 7/02; F16D 65/097; F16D 69/04

(52) U.S. Cl. CPC F03D 7/0248; F16D 65/0971; F16D 69/04; F05B 2260/902

(57) ABSTRACT

A brake unit for a wind turbine is provided. The brake unit can include a mounting ring configured to couple the brake unit with the wind turbine, a piston movably coupled with the mounting ring such that an upper portion of the piston is positioned and located proximate to the mounting ring, a lining coupled with the piston, wherein the lining is positioned and located adjacent to an opposing end of the piston from the mounting ring, and a gap positioned between a first component of the brake unit and a second component of the brake unit, wherein the gap is configured to indicate a thickness of the lining.

### CROSS-REFERENCE TO RELATED APPLICATIONS

None.

### BACKGROUND OF THE INVENTION

The present invention relates generally to a brake unit for a wind turbine. More specifically, the present invention relates to a brake unit that is configured for visual inspections and easy-to-perform maintenance routines.

Wind turbines include a variety of motor and braking mechanisms to move and hold various components of the wind turbine in a particular direction, angle, or orientation. One such motor and braking system is the yaw control system, which is responsible for controlling the horizontal orientation of the rotor (e.g., such that an axis of rotation is parallel to the direction of the wind).

For instance, the rotor of a wind turbine may be positioned and located on a nacelle assembly that is rotatably coupled with the tower of the wind turbine. In such instances, the orientation of the rotor may be adjusted by rotating the nacelle assembly relative to the tower. For example, the nacelle assembly may include one or more motors that engage with a slew gear coupled with the tower to rotate the nacelle assembly relative to the tower.

The yaw control system may also include one or more brake units to help prevent the nacelle assembly from rotating relative to the tower. Each of the one or more brake units may be configured as a passive brake unit such that the one or more brake units are continuously engaged to help prevent rotation of the nacelle assembly relative to the tower. When the turbine requires rotation to align with the wind direction, the yaw control system rotates the nacelle assembly via large gear reducers that drive through and overcome the frictional engagement of the passive brake units. In some instances, the one or more brake units may be coupled with the nacelle assembly and may include a lining configured to engage with the tower to generate friction.

FIG. 1 illustrates an example of a prior art brake unit 10 (hereinafter, the brake unit 10) coupled with a bed plate 12 of a wind turbine 14 (only partially illustrated). The brake unit 10 generally comprises three primary portions: a housing 16 received by the bed plate 12, a piston 18 slidably retained in the housing 16, and a lining 20 coupled with the piston 18 and configured to engage with a slew gear 22 of the wind turbine 14. The housing 16 is provided in a generally cylindrical shape with an opening 24 extending through the housing 16 in an axial direction 25 with respect thereto. The piston 18 can be positioned and located in the opening 24 of the housing 16 such that the piston 18 is movable along the axial direction 25 of the housing 16.

The lining 20 may be integrally formed with a lower end 26 of the piston 18 such that the lining 20 is positioned and located adjacent to the slew gear 22. Further, a spring 28 compressed between the piston 18 and a guide member 30 may apply a downward or outward force to the piston 18. The force applied to the piston 18 may move the piston 18 toward the slew gear 22 to help develop a contact force between the lining 20 and the slew gear 22. Thus, the spring 28 preferably pushes the lining 20 into contact with the slew gear 22 to help prevent movement of the brake unit 10 relative to the slew gear 22.

However, the friction generated by the brake unit 10 may cause the lining 20 of the brake unit 10 to wear or degrade over time. As a result, the thickness of the lining 20 may decrease. As the thickness of the lining 20 decreases, the spring 28 may become less compressed as it pushes the piston 18 further downward to maintain contact between the lining 20 and the slew gear 22. When the spring 28 becomes less compressed, it may apply less force to the piston 18. Accordingly, the prior art brake unit 10 may include an adjustment bolt 32 that is selectively movable for increasing or decreasing the compression of the spring 28.

Prior solutions and prior art brake units (including brake unit 10 described above) have several deficiencies. For example, the lining 20 in prior art brake units 10 tends to wear out relatively quickly (e.g., every 1.5 years). When the lining 20 wears out, the entire brake unit 10 must be replaced. However, it can be relatively expensive and burdensome to replace the brake unit 10. This leads some wind turbine owners to neglect replacing a brake unit 10 when the lining 20 is worn. However, when the lining 20 is worn, the piston 18 can make contact with the slew gear 22 causing irreparable damage to the slew gear 22 and other portions of the wind turbine 14.

To facilitate preventative maintenance, some wind turbine owners may wish to measure the compression of the spring 28 and/or forecast the remaining useable life of the lining 20. However, for prior art brake units, it is quite difficult to accurately measure the compression of the spring 28 or the remaining thickness of the lining 20. Instead, maintenance personnel must record several measurements and perform a series of calculations, which can oftentimes be inaccurate. For example, maintenance personnel typically insert a measurement device in a first aperture 34 (see FIG. 1) to record a first measurement value (e.g., related to the position of the guide member 30). Then, maintenance personnel may insert another measurement device in a second aperture 36 to record a second measurement value (e.g., related to the position of the piston 18). An estimated compression of the spring 28 is determined using these two first and second measurement values, and then, using the estimated compression of the spring 28 and the first and second measurement values, a calculation may be performed to roughly estimate the thickness of the lining 20.

In addition, it can be quite difficult to lubricate mechanical interfaces (e.g., between the housing 16 and the piston 18) in prior art brake units 10. As a result, many wind turbine owners neglect to apply grease or lubricant to maintain the mechanical interfaces. However, this neglect may cause excess friction to develop at the mechanical interfaces of the brake unit 10, which can lead to a seized piston 18 or cracks in the housing 16 and the piston 18.

Accordingly, there is a need for a brake unit that is more durable and easier and more efficient to maintain and monitor. A need exists for a brake unit with a replaceable lining and/or a lining with a longer useable life. A need also exists for a brake unit configured to allow a user to easily measure and/or visually inspect the thickness of the lining and/or the compression of the spring. In addition, there is a need for a brake unit that is easy and convenient to lubricate.

Accordingly, the present invention has for its object to obviate or at least reduce the above-stated problems with known brake units.

### SUMMARY OF THE INVENTION

The present invention is directed generally to a brake unit for a wind turbine. Through various means, the brake unit may be configured to facilitate visual inspections and convenient maintenance routines.

According to one embodiment of the present invention, the brake unit for a wind turbine may include a mounting ring configured to couple the brake unit with the wind turbine, a piston movably coupled with the mounting ring, wherein an upper portion of the piston is positioned and located proximate to the mounting ring, a lining coupled with the piston, wherein the lining is positioned and located adjacent to an opposing end of the piston from the mounting ring, and a gap positioned between a first component of the brake unit and a second component of the brake unit, wherein the gap is configured to indicate a thickness of the lining. In one such embodiment, the brake unit can further include an adjustment nut that is selectively rotatable to move the piston along an axial direction relative to the mounting ring. In addition, the mounting ring and the adjustment nut can define the gap configured to indicate the thickness of the lining. In one embodiment, the brake unit further includes one or more fittings configured to receive a lubricant and direct the lubricant toward an outer surface of the piston. In addition, the brake unit can further include a spring mechanism configured to apply a force to the piston, wherein a spring adjustment nut is selectively rotatable to change the force applied by the spring mechanism. Further, the brake unit can include an indicator rod coupled with the piston such that a position of the indicator rod relative to a position of the spring adjustment nut indicates the force being applied by the spring mechanism. In one embodiment, the lining comprises at least one of polyester, polytetrafluoroethylene, resin, molybdenum disulfide, graphite, or a combination thereof.

In another embodiment, the brake unit for a wind turbine may include a mounting ring configured to couple the brake unit with the wind turbine, a piston movably coupled with the mounting ring, a spring configured to apply a force to the piston to move the piston relative to the mounting ring, a first adjustment nut configured to adjust the force applied by the spring, and an indicator rod coupled with the piston and received by the first adjustment nut, wherein a position of the indicator rod relative to a position of the first adjustment nut indicates a length value corresponding to a compression of the spring. In one such embodiment, the brake unit is configured such that an upper surface of the indicator rod is positioned flush with an upper surface of the first adjustment nut when the spring is compressed by a first threshold length value. In addition, the brake unit can be configured such that the upper surface of the indicator rod is positioned above the upper surface of the first adjustment nut when the spring is compressed by a length value greater than the first threshold length value. In one embodiment, the first end of the spring engages with a guide member, and the first adjustment nut is configured to selectively move the guide member. In another embodiment, the brake unit further includes a second adjustment nut configured to move the piston relative to the mounting ring, and the first adjustment nut is received by the second adjustment nut. In one such embodiment, one or more fasteners can be configured to engage with the second adjustment nut to resist rotation of the second adjustment nut relative to the mounting ring. In one other embodiment, a lock nut is configured to engage with the first adjustment nut to resist rotation of the first adjustment nut relative to the second adjustment nut.

In yet a further embodiment, the brake unit for a wind turbine may include a mounting ring configured to couple the brake unit with the wind turbine, a piston movably coupled with the mounting ring, a spring mechanism coupled with the piston, a first adjustment nut configured to engage with the spring mechanism to selectively adjust a value associated with the spring mechanism, and a second adjustment nut configured to engage with the piston to move the piston relative to the mounting ring. In one such embodiment, the first adjustment nut is received by the second adjustment nut. In addition, the second adjustment nut can be coupled with the mounting ring by a threaded connection. In one embodiment, the first adjustment nut is configured to adjust a length value associated with a compression of the spring mechanism. In another embodiment, an inner surface of the piston includes a threaded portion configured to engage with a piston puller to facilitate decoupling the piston from the wind turbine. In one other embodiment, the brake unit further includes a lining removably coupled with the piston such that the lining is selectively replaceable.

Further advantages, features and details of the invention are elucidated on the basis of preferred embodiments thereof, wherein reference is made to the accompanying drawings.

### DESCRIPTION OF THE SEVERAL VIEWS OF THE DRAWINGS

In the accompanying drawings, which form a part of the specification and are to be read in conjunction therewith, like reference numerals are used to indicate like or similar parts in the various views:

FIG. 1 is a cross-sectional front elevation view of a brake unit for a wind turbine as currently known in the art, the brake unit being received by the wind turbine;

FIG. 2 is a perspective view of a brake unit for a wind turbine according to one embodiment of the present invention;

FIG. 3 is a side elevation view of the brake unit of FIG. 2;

FIG. 4 is a cross-sectional front elevation view of the brake unit of FIG. 2 taken generally about line 4-4 (see FIG. 3) in the direction of the arrows; and

FIG. 5 is a partial cross-sectional front elevation view of a wind turbine coupled with the brake unit of FIG. 2.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized, and changes can be made without departing from the scope of the present invention.

The present invention is directed to a friction mechanism, brake mechanism, or brake unit 100. Generally, the brake unit 100 is configured to couple with a first component, and the brake unit 100 is configured to engage with a second component to resist movement of the first component relative to the second component. In one embodiment, the brake unit 100 may be configured for use in a wind turbine assembly. In particular, the brake unit 100 may be adapted for coupling with a bed plate in a nacelle assembly of a wind turbine, and the brake unit 100 may be a passive brake unit configured to continuously engage with a slew gear in the yaw control system of a wind turbine. Accordingly, the brake unit 100 may be adapted to resist movement of the nacelle assembly relative to the slew gear. However, it will be appreciated that the brake unit 100 can also be used with other portions of a wind turbine, or the brake unit 100 may be used in other applications (e.g., diesel generators, axial fans, self-propelled vehicles, or other machinery).

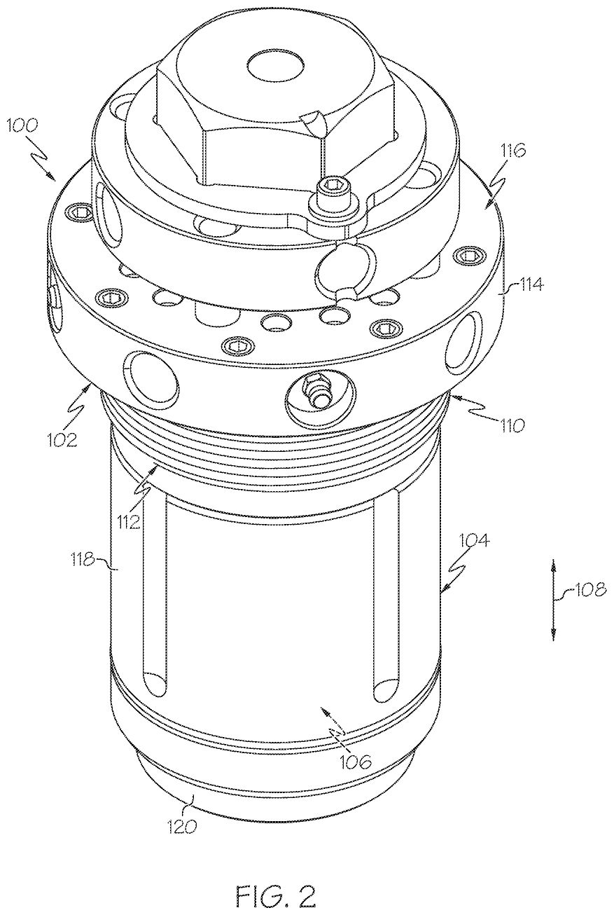

Referring to FIG. 2, a brake unit 100 according to one embodiment of the present invention may generally include a base, mounting portion, adapter, or mounting ring 102 configured to couple the brake unit 100 with a wind turbine (not illustrated), a piston 104 movably coupled with the mounting ring 102, and a spring mechanism 106 configured to move the piston 104 relative to the mounting ring 102.

The mounting ring 102 may be provided as a tubular or cylindrical body extending along an axial direction 108 with a first outer surface 110 configured to couple the mounting ring 102 with a wind turbine. For example, the first outer surface 110 may include threads for coupling the mounting ring 102 with a wind turbine, although other suitable configurations for coupling the first outer surface 110 with a wind turbine are also contemplated (e.g., a friction fit configuration, a snap-fit configuration, etc.). The first outer surface 110 may be positioned and located proximate to a lower end 112 of the mounting ring 102, and a shoulder or flange 114 may be provided proximate to an upper end 116 of the mounting ring 102. However, other configurations for the mounting ring 102 are also contemplated.

The piston 104 may also be provided as a cylindrical or tubular body extending along the axial direction 108. A base portion 118 of the piston 104 may be positioned and located proximate to the mounting ring 102 and may comprise a relatively smooth material (e.g., 4140 HT steel, another steel alloy, another metal, or a combination thereof). In contrast, a brake pad, brake puck, friction element, or lining 120 may be coupled with the base portion 118 on an opposing end of the piston 104 from the mounting ring 102. The lining 120 may be cylindrical-shaped and made of a material configured to generate friction. Such material may comprise any suitable material typically used for friction pads or linings in passive brake units or other brake systems, including without limitation, composite materials. For example, the lining 120 may comprise at least one of polyester, polytetrafluoroethylene, resin, molybdenum disulfide, graphite, or a combination thereof. Other materials, shapes, and configurations for the piston 104 are also contemplated and considered within the scope of the present invention.

The spring mechanism 106 is enclosed by the piston 104 and the mounting ring 102 such that the spring mechanism 106 is hidden in FIG. 2. However, the spring mechanism 106 may be engaged with the mounting ring 102 and the piston 104 such that the spring mechanism 106 is configured to apply a force to the piston 104. The force applied by the spring mechanism 106 may help to move the piston 104 along the axial direction 108 relative to the mounting ring 102. As a result, the spring mechanism 106 may move the lining 120 into contact with an adjacent component of the wind turbine. In addition, the force applied by the spring mechanism 106 may help to generate a contact force between the lining 120 and the component engaged therewith (e.g., to help generate friction therebetween). As described in additional detail below, the brake unit 100 is typically installed into a cylinder or bore hole formed on the wind turbine and the lining 120 is positioned adjacent to and engages the base of the bore hole within the cylinder.

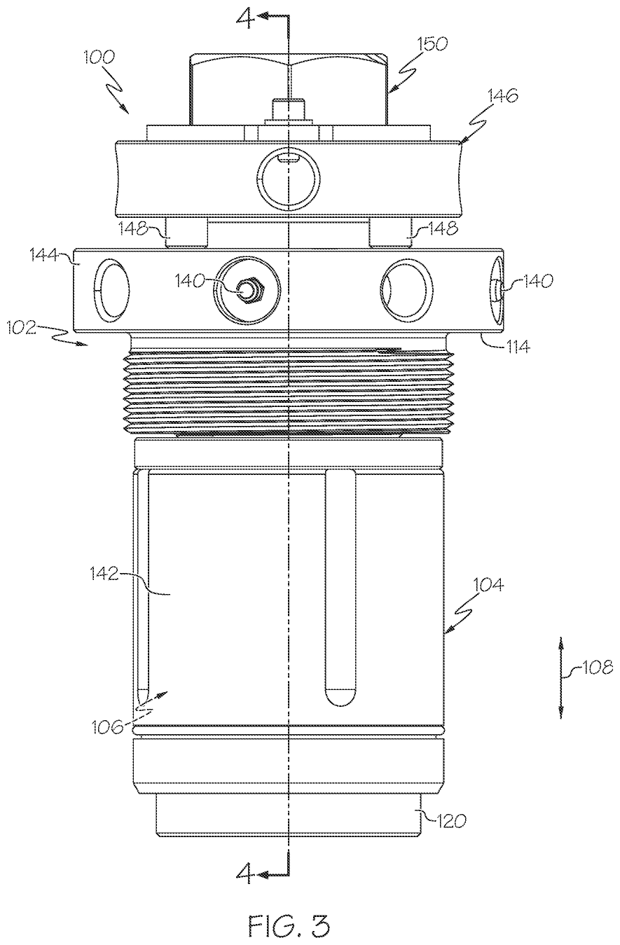

As illustrated in FIG. 3, the brake unit 100 may further include one or more features to help maintenance personnel maintain and/or adjust the brake unit 100. For example, the brake unit 100 may include one or more inlets, fittings, or grease zerks 140 configured to receive a lubricant (e.g., grease) and to direct the lubricant to the mechanical interfaces of the brake unit 100 (e.g., to an outer surface 142 of the piston 104). As illustrated, the one or more grease zerks 140 may be positioned and located on the flange 114 of the mounting ring 102. In particular, four grease zerks 140 (only two shown in FIG. 3 due to perspective) may be spaced circumferentially along a second outer surface 144 of the mounting ring 102. However, other configurations for the grease zerks 140 are also contemplated, and more than four or less than four grease zerks 140 may be configured within the brake unit 100 in suitable embodiments of the brake unit 100.

In addition, the brake unit 100 may include a piston calibration knob, piston adjustment screw, or lining adjustment nut 146 for adjusting or changing the position of the piston 104 and the position of the lining 120 to compensate for changes in the thickness of the lining 120. The lining adjustment nut 146 may be received by the mounting ring 102 such that the lining adjustment nut 146 is selectively movable along the axial direction 108 relative to the mounting ring 102. In particular, the lining adjustment nut 146 may be coupled with the mounting ring 102 via a threaded connection such that the lining adjustment nut 146 moves along the axial direction 108 when the lining adjustment nut 146 is rotated relative to the mounting ring 102. As the lining adjustment nut 146 moves along the axial direction 108, the lining adjustment nut 146 may engage with the piston 104 to move the piston 104 along the axial direction 108. Accordingly, maintenance personnel may rotate the lining adjustment nut 146 to compensate for changes in the thickness of the lining 120.

In addition, the brake unit 100 may include one or more first fasteners 148 to help prevent the lining adjustment nut 146 from unintentionally rotating relative to the mounting ring 102 (e.g., due to vibrations). The one or more first fasteners 148 may be selectively extendable through the lining adjustment nut 146 such that the one or more first fasteners 148 are received by the mounting ring 102. When the one or more first fasteners 148 are extended through the lining adjustment nut 146 and received by the mounting ring 102, the one or more first fasteners 148 may couple the lining adjustment nut 146 with the mounting ring 102. Accordingly, the one or more first fasteners 148 may help to prevent the lining adjustment nut 146 from rotating due to vibrations.

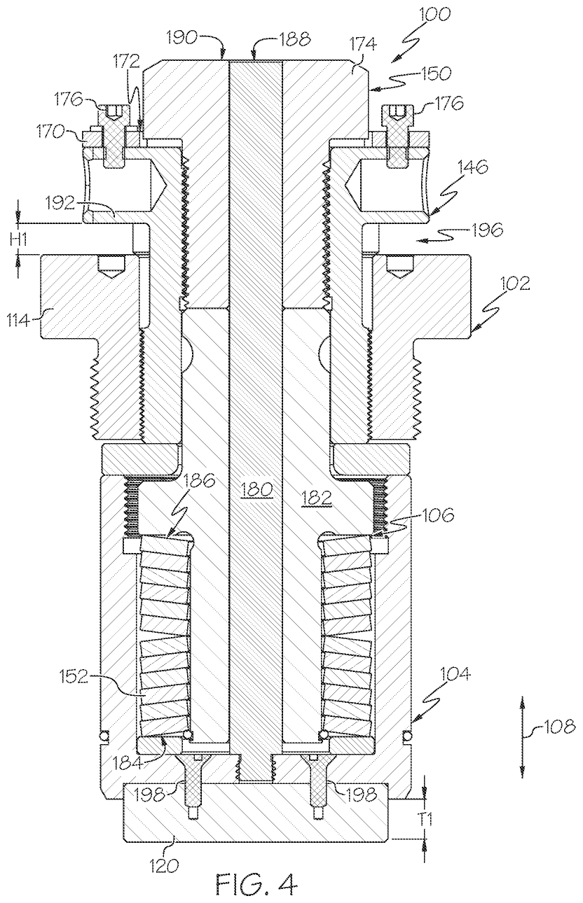

The brake unit 100 may also include a spring force calibration knob, spring force adjustment screw, or spring adjustment nut 150 for adjusting or changing the compression of the spring mechanism 106 to thereby adjust the force applied to the piston 104. The spring adjustment nut 150 may be received by the lining adjustment nut 146 such that the spring adjustment nut 150 is selectively movable along the axial direction 108 relative to the lining adjustment nut 146. In particular, the spring adjustment nut 150 may be coupled with the lining adjustment nut 146 via a threaded connection such that the spring adjustment nut 150 moves along the axial direction 108 when the spring adjustment nut 150 is rotated relative to the lining adjustment nut 146. As the spring adjustment nut 150 moves along the axial direction 108, the spring adjustment nut 150 may increase or decrease the compression of a spring 152 (see FIG. 4) of the spring mechanism 106, which may in turn increase or decrease the force applied by the spring mechanism 106. Thus, the force applied by the spring mechanism 106 may be selectively adjustable by rotating the spring adjustment nut 150 relative to the lining adjustment nut 146.

As best illustrated in FIG. 4, a washer, plate, or lock collar 170 may help to prevent the spring adjustment nut 150 from unintentionally rotating relative to the lining adjustment nut 146 (e.g., due to vibrations). The lock collar 170 may be a disk-shaped plate with an opening 172 sized and shaped similarly to a head 174 of the spring adjustment nut 150. For example, the opening 172 may be a hexagonal-shaped aperture, and the head 174 may be shaped as a hexagonal prism. Thus, the lock collar 170 may receive the head 174 of the spring adjustment nut 150 to couple the lock collar 170 therewith. In addition, one or more second fasteners 176 may be selectively extended through the lock collar 170 and received by the lining adjustment nut 146. Thus, the lock collar 170 may help to couple the spring adjustment nut 150 with the lining adjustment nut 146 to preferably prevent rotation of the spring adjustment nut 150 relative to the lining adjustment nut 146.

As further illustrated in FIG. 4, the brake unit 100 may also include one or more additional features to help maintenance personnel inspect and/or perform maintenance on the brake unit 100. For example, the spring adjustment nut 150 and a shaft, bar, rod, gauge, indicator, or indicator rod 180 may help to indicate a length value corresponding to the compression of the spring 152, which may be proportionally related to the force being applied by the spring mechanism 106. In particular, the indicator rod 180 may be coupled with the piston 104, and the spring adjustment nut 150 may abut a guide 182. Because the first end 184 of the spring 152 engages with the piston 104 and the second end 186 engages with the guide 182, the position of the indicator rod 180 relative to the position of the spring adjustment nut 150 may indicate the position of the first end 184 of the spring 152 relative to the position of the second end 186. Accordingly, maintenance personnel may measure or visually inspect the position of the indicator rod 180 relative to the position of the spring adjustment nut 150 to determine a length value associated with the compression of the spring 152.

In some instances, the brake unit 100 may be configured to visually indicate the position of the indicator rod 180 relative to the position of the spring adjustment nut 150 to help maintenance personnel determine whether the brake unit 100 requires maintenance. For example, in some exemplary embodiments, an upper surface 188 of the indicator rod 180 may be positioned between about 0.50 mm and about 1.00 mm, or between about 0.020 inches and about 0.039 inches, above an upper surface 190 of the spring adjustment nut 150 when the brake unit 100 is installed. As the lining 120 wears and/or as the spring 152 becomes less compressed, the indicator rod 180 may move downwardly until the upper surface 188 of the indicator rod 180 is positioned flush with or below the upper surface 190 of the spring adjustment nut 150. When the upper surface 188 of the indicator rod 180 is positioned flush with or below the upper surface 190 of the spring adjustment nut 150, the brake unit 100 may be due for maintenance. For example, the lining adjustment nut 146 and/or the spring adjustment nut 150 may require adjustment, and/or the lining 120 may require replacement. Thus, maintenance personnel may inspect the position of the indicator rod 180 relative to the position of the spring adjustment nut 150 to determine whether the brake unit 100 requires maintenance. It is also to be recognized that the foregoing relative displacement distances of the indicator rod 180 from the upper surface 190 of the spring adjustment nut 150 are representative of only one exemplary embodiment, and the brake unit 100 may be configured with different relative displacement distances in alternative configurations and embodiments.

In some instances, the position of the indicator rod 180 relative to the position of the spring adjustment nut 150 may help maintenance personnel determine the compression of the spring 152 via a visual inspection. For example, the upper surface 188 of the indicator rod 180 may be positioned flush with the upper surface 190 of the spring adjustment nut 150 when the spring mechanism 106 is compressed by a first threshold length value. In contrast, when the spring 152 is compressed by a second threshold length value that is greater than the first threshold length value, the upper surface 188 of the indicator rod 180 may be positioned above the upper surface 190 of the spring adjustment nut 150. According to one exemplary embodiment, the indicator rod 180 may be about 0.050 inches above the upper surface 190. Further, when the spring 152 is compressed by a third threshold length value that is less than the first threshold length value, the upper surface 188 of the indicator rod 180 may be positioned below the upper surface 190 of the spring adjustment nut 150. According to one exemplary embodiment, the indicator rod 180 may be about 0.050 inches below the upper surface 190. Accordingly, maintenance personnel may measure or visually inspect the position of the upper surface 188 of the indicator rod 180 relative to the position of the spring adjustment nut 150 to determine the compression of the spring 152 and the force being applied by the spring mechanism 106. The foregoing relative displacement distances of the indicator rod 180 from the upper surface 190 of the spring adjustment nut 150 and the threshold length values are representative of only one exemplary embodiment, and it is recognized that the brake unit 100 may be configured with different distances and values in alternative configurations and embodiments.

In certain exemplary embodiments, the first threshold length value may be about 0.050 inches, the second threshold length value may be about 0.100 inches, and the third threshold length value may be about 0.00 inches. In such instances, the spring mechanism 106 may apply a force of about 25,000 lbf. when the spring 152 is compressed by the first threshold length value, about 50,000 lbf. when the spring 152 is compressed by the second threshold length value, and about 0 lbf. when the spring 152 is compressed by the third threshold length value. However, the foregoing represents only one exemplary embodiment, and in other instances, the first threshold length value, the second threshold length value, and the third threshold length value may correspond to different length values and/or different force values. It is further recognized that the first, second and third threshold length values may be defined as ranges (e.g., plus or minus 0.100 inches, or plus or minus 0.050 inches) rather than specific values.

In addition, the brake unit 100 may be configured to visually indicate a thickness T1 of the lining 120. In particular, the lining adjustment nut 146 may include a flange or lip 192 that moves toward the flange 114 of the mounting ring 102 as the lining adjustment nut 146 is moved downwardly along the axial direction 108. When the lip 192 is adjacent to the flange 114, the thickness T1 of the lining 120 may be relatively small such that the lining 120 is due for replacement. For example, the thickness T1 of the lining 120 may about 0.125 inches when the lip 192 is adjacent to the flange 114. In contrast, when a gap 196 is provided between the lip 192 and the flange 114, the thickness T1 of the lining 120 may be adequate to continue using the lining 120 (e.g., greater than about 0.125 inches). In addition, a height H1 of the gap 196 may correspond to the thickness T1 of the lining 120 that remains until the lining 120 is due for replacement. Thus, maintenance personnel may measure or visually inspect the gap 196 to determine the thickness T1 of the lining 120.

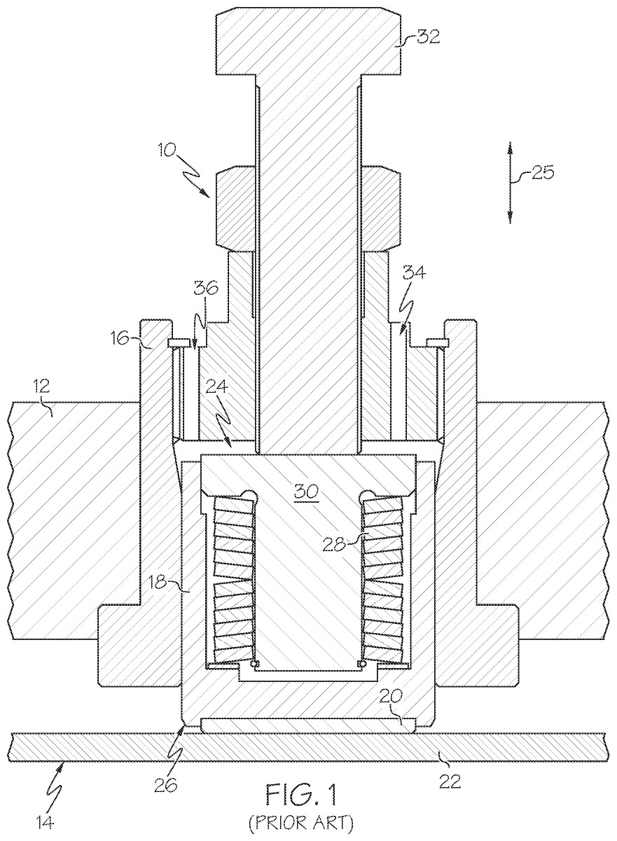

Referring still to FIG. 4, the lining 120 may be coupled with the piston 104 by one or more third fasteners 198 extending through the piston 104. Accordingly, maintenance personnel may selectively decouple the lining 120 from the piston 104 to replace the lining 120 when the lining 120 is worn. In addition, the lining 120 may be an elongated body, unlike the lining 20 of prior art brake units 10 (see, e.g., FIG. 1). Therefore, the lining 120 may require replacement less often than prior art brake units 10. For example, the lining 120 may be about 0.500 inches thick, with about 0.350 inches of the lining 120 being usable before the lining 120 is due for replacement and about 0.375 inches of the lining 120 being usable before the lining 120 is considered fully worn. In contrast, the lining 20 (see, e.g., FIG. 1) of prior art brake units 10 is about 0.075 inches thick. As a result, the lining 120 may only require replacement approximately once every 7.5 years, whereas prior art brake units 10 may require replacement every 1.5 years.

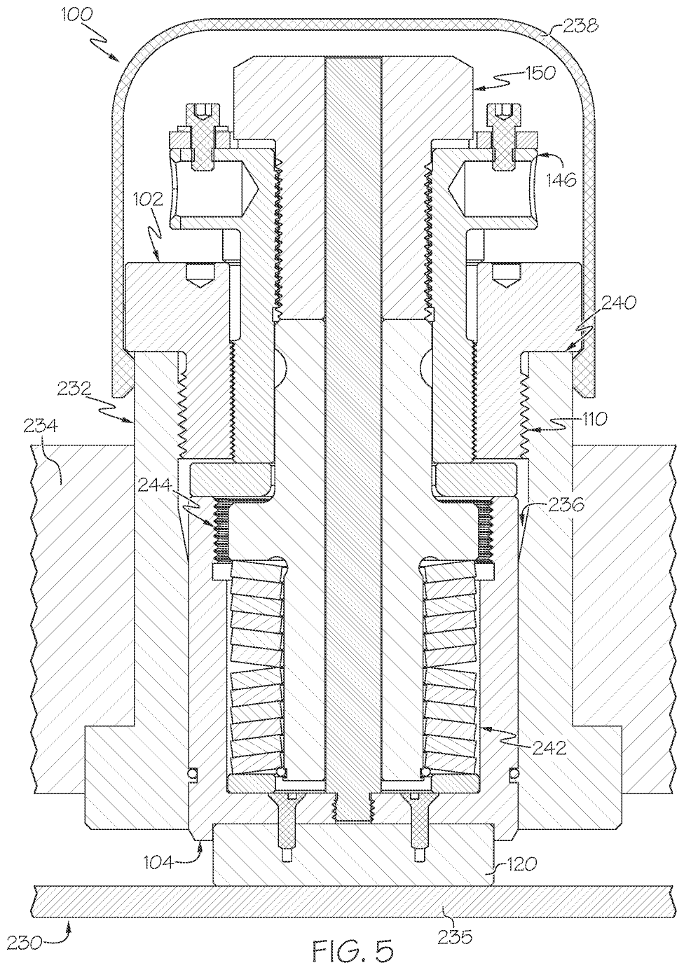

Turning to FIG. 5, when the brake unit 100 is installed in a wind turbine 230, the brake unit 100 may be received in a bushing, adapter, sleeve, bore, or cylinder 232 coupled with the bed plate 234 of the wind turbine 230, and the lining 120 may be positioned to engage with a slew gear 235 of the wind turbine 230. The cylinder 232 may be a tubular body sized and shaped to couple with the bed plate 234 via a friction fit. In addition, a tube, cavity, bore, or channel 236 extending through the cylinder 232 may be configured to receive the mounting ring 102 and the piston 104. In particular, the channel 236 may engage with the first outer surface 110 via a threaded connection, and the piston 104 may be movably retained in the channel 236. However, in other instances, the cylinder 232 may couple with the mounting ring 102 and the piston 104 using other means known in the art.

Prior to inserting the brake unit 100 into the cylinder 232, the piston 104, the lining 120, and the cylinder 232 may have a light coating of grease or other lubricating substance applied thereto. The piston 104 portion of the brake unit 100 may be inserted into the bore 236 of cylinder 232 so that the lining 120 engages the slew gear 235 at the base of the bore 236, and the mounting ring 102 may be secured within the bore 236 via a threaded connection. In some exemplary embodiments, the mounting ring 102 is configured to receive an Allen wrench, a socket extension, a screwdriver, or another elongated member such that maintenance personnel may use an Allen wrench, a socket extension, or a screwdriver as a handle for rotating the mounting ring 102. Once the mounting ring 102 is coupled with the cylinder 232 via the threaded connection, the lining adjustment nut 146 may be rotated using an Allen wrench, a socket extension, a screwdriver, or another elongated member, and the first fasteners 148 (see, e.g., FIG. 3) may be engaged to secure the lining adjustment nut 146 to the mounting ring 102. Then, maintenance personnel may use a hydraulic torque tool or a slam wrench to rotate the spring adjustment nut 150. Thus, maintenance personnel may install the brake unit 100 in a wind turbine 230 using relatively few tools. It is also to be recognized that the foregoing method for installing the brake unit 100 in a wind turbine 230 is representative of only one exemplary embodiment, and other methods may be used to couple the brake unit 100 with a wind turbine 230 in alternative configurations and embodiments.

When the brake unit 100 is coupled with the wind turbine 230, a cap, cover, jacket, casing, enclosure, or boot 238 may shield the brake unit 100 from the surrounding environment. The boot 238 may be made at least partially of a rubber material, and the boot 238 may be shaped and configured to enclose an upper end 240 of the cylinder 232. For example, the boot 238 may be shaped as a hollow cylinder, and the boot 238 may include a selectively deformable tension ring (not illustrated) molded therein. Prior to coupling the boot 238 with the brake unit 100, a coating of grease or other lubricating substance may be applied to the boot 238. Then, the tension ring may be stretched or otherwise deformed to facilitate receiving the mounting ring 102 in the boot 238. Once the mounting ring 102 is received in the boot 238, the tension ring may be released and allowed returned to its original shape (or close thereto) such that the boot 238 is coupled with the brake unit 100 by the compression of the tension ring around the mounting ring 102 and/or the cylinder 232. However, in other instances, the boot 238 may be shaped or configured differently. For example, in some alternative embodiments, the boot 238 may be configured to couple with the mounting ring 102 and the cylinder 232 via a snap-fit connection, a friction fit connection, or a threaded connection. In yet other embodiments, the boot 238 may be configured to couple with the bed plate 234 or just one of the mounting ring 102 and the cylinder 232.

To perform maintenance on the brake unit 100, maintenance personnel may selectively decouple the brake unit 100 from the wind turbine 230. For example, maintenance personnel may wish to decouple the piston 104 from the cylinder 232 when replacing the lining 120. To help with removing the piston 104 from the cylinder 232 (e.g., when the piston 104 is seized due to a lack of lubrication), the piston 104 may be configured for use with a piston puller (not illustrated). In some exemplary embodiments, the piston puller may be a manual piston puller or a hydraulic piston puller. An inner surface 242 of the piston 104 may include threads 244 configured to engage with the piston puller. Accordingly, maintenance personnel may engage the piston puller with the inner surface 242 of the piston 104 to pull the piston 104 out from the wind turbine 230. Representative examples of piston pullers are sold by Carlson Company of Wichita, Kansas, such as the Yaw Brake Piston Puller (Threaded), Part Number: CS7600-01. Once the piston 104 is removed from the cylinder 232, maintenance personnel may inspect the cylinder 232 to verify that the lining 120 has been completely removed. Maintenance personnel may further inspect the mounting ring 102, the piston 104, and the cylinder 232 to verify there are no surface defects. Then, maintenance personnel may clean the bore 236, replace the lining 120, and/or replace the piston 104. Prior to reinstalling the piston 104, a coating of grease may be applied to the mounting ring 102, the piston 104, and the bore 236 to facilitate future removal of the piston 104 from the cylinder 232.

Further embodiments of brake units may have different configurations, components, or dimensions than those specified above. The present invention is by no means limited to the above described preferred embodiments thereof. The rights sought are defined by the following claims within the scope of which many modifications can be envisaged.

Persons of ordinary skill in the relevant arts will recognize that the subject matter hereof may comprise fewer features than illustrated in any of the individual embodiments described above. The embodiments described herein are not meant to be an exhaustive presentation of how the various features of the subject matter herein may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. These are only examples of what is specifically intended, and all possible combinations of numerical values between the lowest value and the highest value enumerated, are to be considered to be expressly stated in this disclosure.

As used herein, “a,” “an,” or “the” can mean one or more than one. For example, “an” image can mean a single image or a plurality of images.

The term “and/or” as used in a phrase such as “A and/or B” herein can include both A and B; A or B; A (alone); and B (alone). Likewise, the term “and/or” as used in a phrase such as “A, B, and/or C” can include at least the following embodiments: A, B, and C; A, B, or C; A or C; A or B; B or C; A and C; A and B; B and C; A (alone); B (alone); and C (alone).

As used herein, the terms “about” and “approximately” when referring to a measurable value such as an amount, a temporal duration, and the like, can include variations of +/−20%, more preferably +/−10%, even more preferably +/−5% from the specified value, as such variations are appropriate to reproduce the disclosed methods and systems.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention.

What is claimed is:

1. A brake unit for a wind turbine comprising:
a mounting ring configured to couple the brake unit with the wind turbine;
a piston movably coupled with the mounting ring, wherein an upper portion of the piston is positioned and located proximate to the mounting ring;
a lining coupled with the piston, wherein the lining is positioned and located adjacent to an opposing end of the piston from the mounting ring; and
a gap positioned between a first component of the brake unit and a second component of the brake unit, wherein the gap is configured to indicate a thickness of the lining.

2. The brake unit of claim 1 further comprising an adjustment nut that is selectively rotatable to move the piston along an axial direction relative to the mounting ring.

3. The brake unit of claim 2, wherein the mounting ring and the adjustment nut define the gap configured to indicate the thickness of the lining.

4. The brake unit of claim 1 further comprising one or more fittings configured to receive a lubricant and direct the lubricant toward an outer surface of the piston.

5. The brake unit of claim 1 further comprising a spring mechanism configured to apply a force to the piston, wherein a spring adjustment nut is selectively rotatable to change the force applied by the spring mechanism.

6. The brake unit of claim 5 further comprising an indicator rod coupled with the piston, wherein the brake unit is configured such that a position of the indicator rod relative to a position of the spring adjustment nut indicates the force being applied by the spring mechanism.

7. The brake unit of claim 1, wherein a thickness of the gap corresponds to the thickness of the lining so that the gap provides a visual indication of the thickness of the lining.

8. A brake unit for a wind turbine comprising:
a mounting ring configured to couple the brake unit with the wind turbine;
a piston movably coupled with the mounting ring;
a spring configured to apply a force to the piston to move the piston relative to the mounting ring;
a first adjustment nut configured to adjust the force applied by the spring; and
an indicator rod coupled with the piston and received by the first adjustment nut;
wherein a position of the indicator rod relative to a position of the first adjustment nut indicates a length value corresponding to a compression of the spring.

9. The brake unit of claim 8, wherein the brake unit is configured such that an upper surface of the indicator rod is positioned flush with an upper surface of the first adjustment nut when the spring is compressed by a first threshold length value.

10. The brake unit of claim 9, wherein the brake unit is configured such that the upper surface of the indicator rod is positioned above the upper surface of the first adjustment nut when the spring is compressed by a length value greater than the first threshold length value.

11. The brake unit of claim 8, wherein a first end of the spring engages with a guide member, and wherein the first adjustment nut is configured to selectively move the guide member.

12. The brake unit of claim 8 further comprising a second adjustment nut configured to move the piston relative to the mounting ring, wherein the first adjustment nut is received by the second adjustment nut.

13. The brake unit of claim 12 further comprising one or more fasteners configured to engage with the second adjustment nut to resist rotation of the second adjustment nut relative to the mounting ring.

14. The brake unit of claim 12 further comprising a lock nut configured to engage with the first adjustment nut to resist rotation of the first adjustment nut relative to the second adjustment nut.

15. A brake unit for a wind turbine comprising:
a mounting ring configured to couple the brake unit with the wind turbine;
a piston movably coupled with the mounting ring;
a spring mechanism coupled with the piston;
a first adjustment nut configured to engage with the spring mechanism to selectively adjust a value associated with the spring mechanism; and
a second adjustment nut configured to engage with the piston to move the piston relative to the mounting ring.

16. The brake unit of claim 15, wherein the first adjustment nut is received by the second adjustment nut.

17. The brake unit of claim 16, wherein the second adjustment nut is coupled with the mounting ring by a threaded connection.

18. The brake unit of claim 15, wherein the first adjustment nut is configured to adjust a length value associated with a compression of the spring mechanism.

19. The brake unit of claim 15, wherein an inner surface of the piston includes a threaded portion configured to engage with a piston puller to facilitate decoupling the piston from the wind turbine.

20. The brake unit of claim 15 further comprising a lining removably coupled with the piston such that the lining is selectively replaceable.
